(19) United States
(12) Patent Application Publication
(10) Pub. No.: US 2005/0150737 A1
(43) Pub. Date: Jul. 14, 2005

(54) Clutch and brake assemblies having equalized pressure distribution

(76) Inventor: Christopher W. Horbach, Crawfordsville, IN (US)

Correspondence Address: PYLE & PIONTEK, 221 N. LASELLE STREET, SUITE 850, CHICAGO, IL, 60601, US

(21) Appl. No.: 11/035,936

(22) Filed: Jan. 14, 2005

Related U.S. Application Data
(60) Provisional application No. 60/536,348, filed on Jan. 14, 2004.

(51) Int. Cl. F16D 25/0638

(52) U.S. Cl. 192/85 AA

(57) ABSTRACT

A clutch and brake assembly is disclosed to provide more uniform distribution of pressure from a piston to the friction members of the clutch or brake assembly and includes at least a special grooved or indented member between the piston and first outer friction member.

### CROSS REFERENCE

This application claims the benefit, filing date and disclosure of Provisional Patent Application Ser. No. 60/536,348, filed Jan. 14, 2004.

### BACKGROUND OF THE INVENTION

This invention relates to clutch and brake mechanism. In particular, this invention relates to such assemblies in which a plurality of active parts are brought together or released to provide an appropriate retardation of the assembly or a release.

With regard especially to hydraulic clutches, many modern assemblies of this nature have a common problem.

A clutch of this nature is composed of or comprises a series of flat ring-shaped rings urged into and out of engagement by a piston acting on one side of the assembly. The rings may comprise a series of parts, including a ring covered with a so-called “friction material,” and/or on a ring of bare metal such as steel. Other known assemblies may comprise a series of disks which are only equipped with a friction material on one side and engage with a substantially identical adjacent part without intervening plates of bare metal, or so-called a single sided disk assembly.

The composition of a “friction material” is well known in the prior art and typically comprises a fiber based textile or nonwoven fabric made from cellulose, or other fibers, such as carbon, aramid and the like. The basic substrate can be made by common papermaking equipment or can be woven, braided, or the like. This substrate is partially impregnated during processing with an uncured organic or synthetic resin such as phenolic, epoxy and known others. This friction material is cut into rings and is applied to the metal ring using heat and pressure, which bonds the friction to the metal base metal ring. Additional adhesives may be used for the purpose of bonding. These assemblies common run in oil to provide lubrication and cooling.

A serious problem with these assemblies is a lack of uniform pressure distribution within the series of the assembly when engaged. This differential can and will result in the creation of localized hot spots, fading, and short service life.

These problems may involve vehicle manufacturers who desire economy, high efficiency and compactness. The suppliers of the parts for the assembly have an excellent engineering and extensive testing equipment. Hence, there is a present need in the prior art for continued improvement, and this continued need has not been adequately resolved.

### BRIEF DESCRIPTION OF THE DRAWINGS

FIG. 1 is a schematic cross-sectional view of a prior art, double sided clutch assembly, marked as such.

FIG. 2 is a schematic cross-sectional view as shown in FIG. 1, but together with the improvements of the present invention.

FIG. 3 is a schematic cross-sectional view of a single sided clutch assembly together with improvements of the present invention.

### DETAILED DESCRIPTION

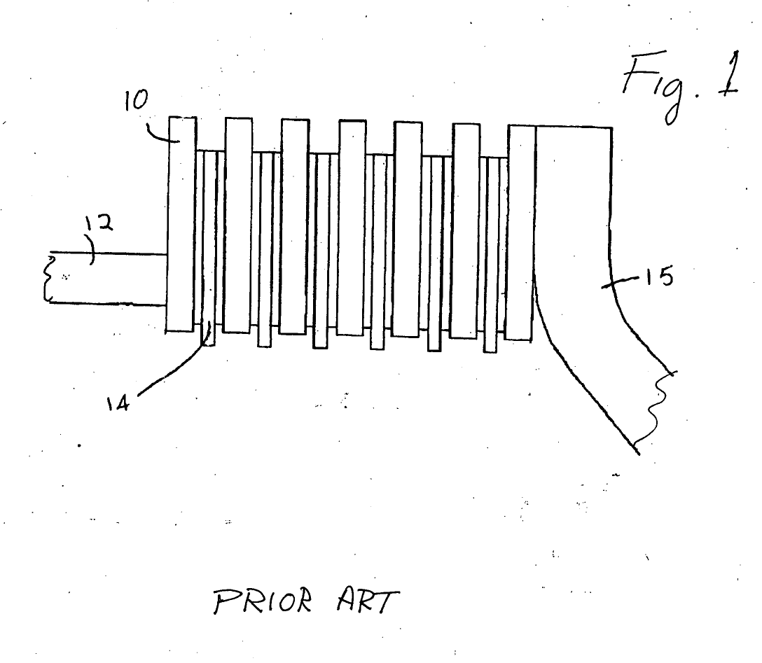

FIG. 1 illustrates what is referred to as a double sided clutch assembly known in the prior art. The assembly comprises a housing partially filled with oil as is well known. The housing contains a clutch assembly as shown comprising a first metal reaction plate 10 engaged by a piston 12, illustrated in the left side of the figure. The piston engages only the lower left-hand side of the assembly at the first reaction plate 10.

The clutch assembly additionally comprises a series of disks with a central axis including friction plates and the entire assembly is supported on the other side by a relatively stationary backing plate 15. The purpose of the assembly is to translate relative rotary motion between parts, to cause the parts to move together, say in a braking or clutching action, for example from an engine into a braking power. The respective adjacent parts of the assembly have inner and outer splines (not shown) in engagement with respectively the drive and stationary elements.

As may be clearly seen, the piston 12 only engages a limited portion of the reaction plate 10 clutch pack, which can cause uneven pressure distribution.

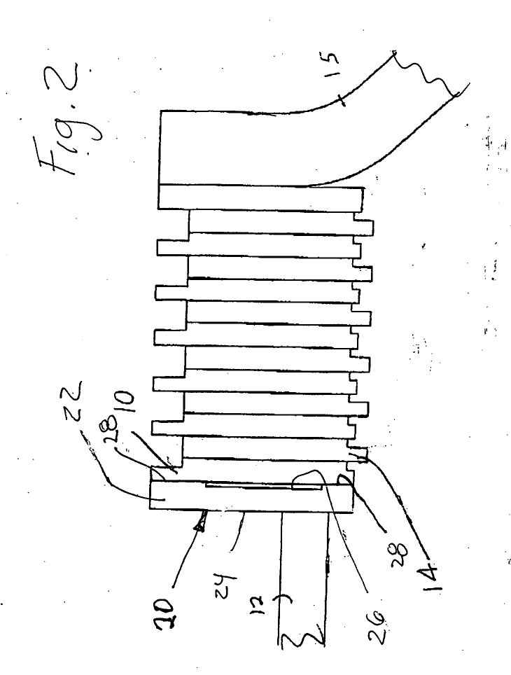

FIG. 2 illustrates the same type of assembly as shown in FIG. 1 with improvements of the present invention, common elements of FIG. 2 are repeated in FIG. 1.

The improvement comprises a transition member or special plate 20 between the piston 12 and first reaction plate 10. This special plate or member comprises a flat disk-shaped member, composed of metals such as steel or titanium. This member 20 comprises a relatively flat disk 22 with a central axis generally aligned with that of the reaction plates, having an outer flat annular surface 24 facing the piston 12, the inner portion in contact with the first reaction plate has a indentation or groove or detent 26 located centrally around the rotational axis of the assembly, with the detent being at a reduced thickness at the inner diameter than the outer, leaving a raised annular periphery 28 engageable with the first reaction plate 10. This allows a more uniform application on the assembly and avoidance of problems aforementioned above.

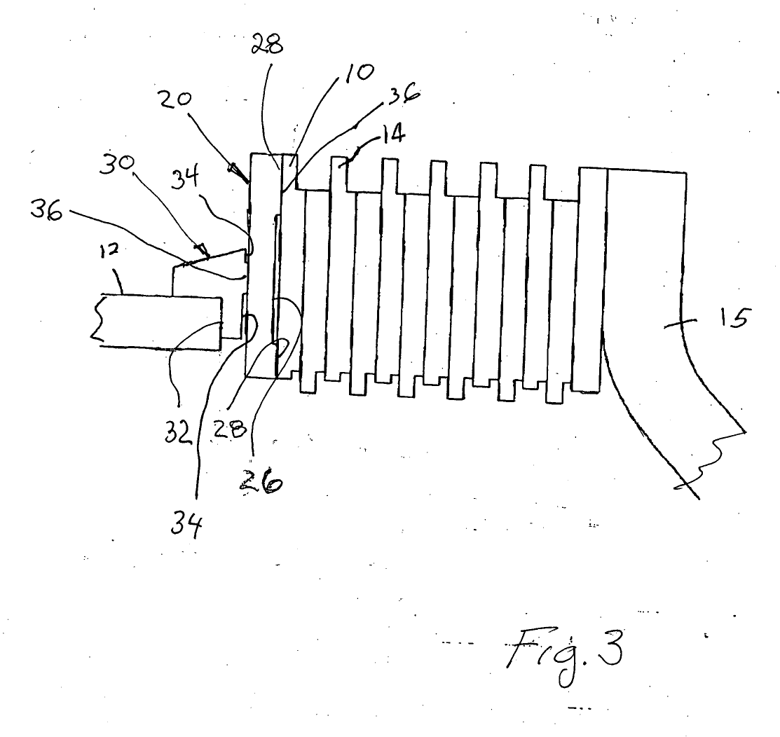

FIG. 3 differs from FIG. 1, in that the assembly shows a single sided clutch as described in the Przemyslaw A. Zagrodzki U.S. Pat. No. 6,484,853, incorporated herein by reference.

For the sake of brevity, this embodiment comprises an intermediate element 30, and another special plate or member 20 between the piston 12 and first reaction plate 10. In this version, there is a detent 32 of the annular member 30, with the detent 32 facing and receiving at least a portion of the piston 12 around the outer circumference of the piston. The inner surface of member 30 comprises a second detent 34 extending around the outer periphery and having a raised portion 36 facing and engageable with the central portion of the plate 20 and then to the first reaction plate 10 allowing for uniform distribution of applied pressure.

As noted above, the described embodiments of the present invention not only result in more even application of engagement, but can also be incorporated without any substantial increase in cost.

The ratios between the detents can be varied to suit a particular application.

1. A clutch assembly comprising a series of reactive disks engageable to and from an assembly, a piston on one side of the assembly, engageable with a first outside disk of said assembly and a relatively stationary support member at the other side of the assembly, thereby providing engagement and release of transmission into and out of the assembly, and an intermediate annular transition between the piston and the first outside disk, said transition member comprising at least one annular depent at at least one side of the transition member, a said transition member having a uniform contact between the piston and the first outside disk of the assembly, thereby providing uniform pressure transmitted from the piston to the assembly.

2. The clutch assembly of claim 1, wherein the detent faces the first outside disk of the assembly, wherein said assembly has a central axis, and wherein the detent extends from the central axis.

3. The clutch assembly of claim 1, wherein said annular detent faces the first outside disk, and wherein said detent extends inward from the outer periphery of the annular member and has a central portion engageable with the first outside disk.

4. The clutch assembly of claim 3, wherein said intermediate member has a second detent facing the piston and receiving at least a portion of the piston.
